(19) United States
(12) Patent Application Publication
(10) Pub. No.: US 2016/0315883 A1
(43) Pub. Date: Oct. 27, 2016

(54) PACKET CONTROL METHOD, TRANSMISSION APPARATUS, AND STORAGE MEDIUM

(71) Applicant: FUJITSU LIMITED, KAWASAKI-SHI (JP)

(72) Inventors: Minyoung BANG, KAWASAKI (JP); Kanta YAMAMOTO, KOKUBUNNJI (JP); Masaaki SAITO, KAWASAKI (JP)

(73) Assignee: FUJITSU LIMITED, KAWASAKI-SHI (JP)

(21) Appl. No.: 15/069,160

(22) Filed: Mar. 14, 2016

(30) Foreign Application Priority Data
Apr. 21, 2015 (JP) 2015-087138

(51) Int. Cl. H04L 12/861; H04L 12/879

(52) U.S. Cl. CPC H04L 49/9057; H04L 49/901

(57) ABSTRACT

A packet control method implemented by a processor provided in a transmission apparatus including a buffer, the method includes sequentially writing a plurality of packets which are received, to a plurality of regions in the buffer, when sequentially receiving the plurality of packets; acquiring time information indicating a time when each of the plurality of packets is written to one of the plurality of regions, for each packet; sequentially reading the plurality of packets from the plurality of regions; determining an order to write a plurality of new packets to the plurality of regions, based on the time information of each of the plurality of packets which are read; and writing the plurality of new packets to the plurality of regions, according to the determined order, when sequentially receiving the plurality of new packets.

### CROSS-REFERENCE TO RELATED APPLICATION

This application is based upon and claims the benefit of priority of the prior Japanese Patent Application No. 2015-087138, filed on Apr. 21, 2015, the entire contents of which are incorporated herein by reference.

### FIELD

The embodiment discussed herein is related to a packet control method, a transmission apparatus, and a storage medium.

### BACKGROUND

An apparatus that receives a packet from another device and temporarily stores the packet in a buffer has been known (for example, Japanese Laid-open Patent Publication No. 2002-300201). In a case where a failure occurs in this type of apparatus, a failure cause is specified by analyzing warnings collected in the apparatus and the logs of the packets stored in the buffer. In particular, the communication environment outside the apparatus is understood from the logs, and also the logs are useful for specifying a failure cause because the logs of packets are also left as snapshots in a plurality of regions in the buffer after reading the packet.

Since the order of the packets which are written to the buffers and the order of the packets which are read from the buffers are different, the priority of reading is provided for each packet. Therefore, the packets are read from the buffer in an order different from the order in which the packets are stored in the buffers.

Accordingly, in a case where the late arrival packet is read earlier than the early arrival packet from the buffer, if a new packet is stored in the region in the buffer in which the late arrival packet was stored, the snapshot of the late arrival packet is overwritten. Therefore, since it is not possible to acquire the logs of the packets before and after the time when a failure occurs, according to the time series, log analysis is difficult. It is desirable that the analysis of the log is easy.

### SUMMARY

According to an aspect of the invention, a packet control method implemented by a processor provided in a transmission apparatus including a buffer, the method includes sequentially writing a plurality of packets which are received, to a plurality of regions in the buffer, when sequentially receiving the plurality of packets; acquiring time information indicating a time when each of the plurality of packets is written to one of the plurality of regions, for each packet; sequentially reading the plurality of packets from the plurality of regions; determining an order to write a plurality of new packets to the plurality of regions, based on the time information of each of the plurality of packets which are read; and writing the plurality of new packets to the plurality of regions, according to the determined order, when sequentially receiving the plurality of new packets.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a transmission apparatus;

FIG. 2 is a configuration diagram illustrating a comparative example of a traffic control unit and a packet buffer (at the time of packet writing);

FIG. 3 is a diagram illustrating an example of a map of the packet buffer;

FIG. 4 is a configuration diagram illustrating the comparative example of the traffic control unit and the packet buffer (at the time of packet reading);

FIG. 5 is a configuration diagram illustrating an example of the traffic control unit and the packet buffer;

FIG. 6 is a configuration diagram illustrating an example of a pointer control unit;

FIG. 7 is a flow chart illustrating an example of an output process for pointer information; and

FIG. 8 is a flow chart illustrating an example of a retrieval process for pointer information.

### DESCRIPTION OF EMBODIMENT

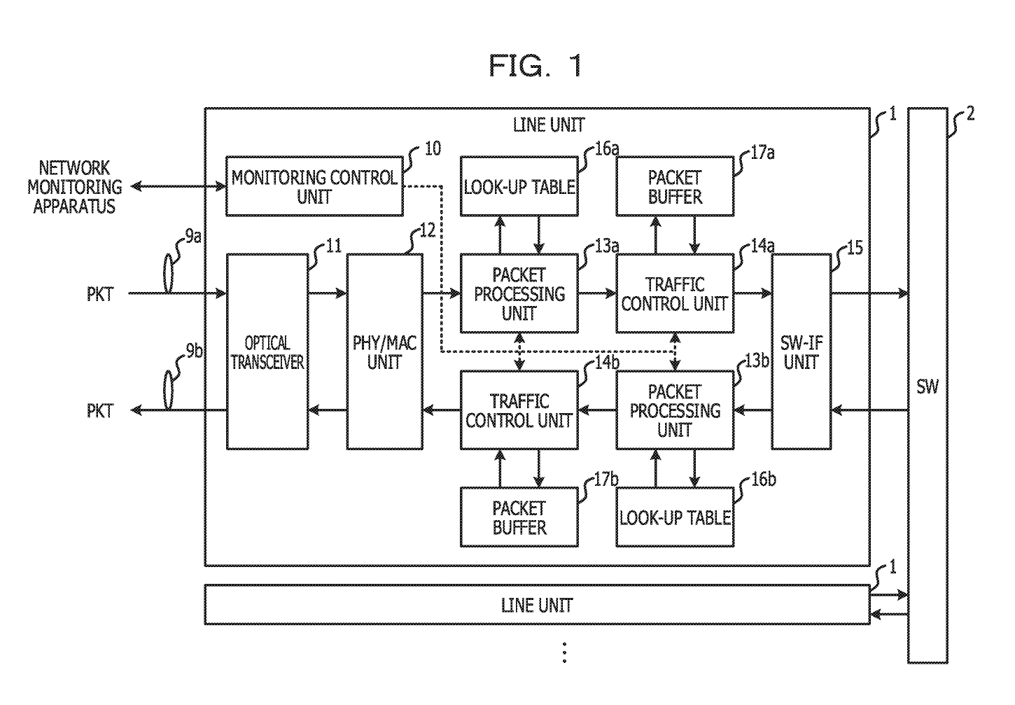

FIG. 1 is a configuration diagram illustrating an example of a transmission apparatus. In the present embodiment, the transmission apparatus is exemplified as a layer-2 switch which transmits a packet received from another apparatus to a destination, but without being limited thereto, other types of transmission apparatuses such as a layer-3 switch may be used. In the present embodiment, a packet is exemplified as an Ethernet (registered trademark, hereinafter, the same is applied) frame, but without being limited thereto, other types of packets such as an internet protocol (IP) packet and an asynchronous transfer mode (ATM) cell may be used.

The transmission apparatus includes a plurality of line units 1 each of which transmits and receives a packet through a communication line, and a switch unit (SW) 2 that exchanges a packet with the plurality of line units 1. The plurality of line units 1 and the switch unit 2 are electrical circuit boards which are respectively inserted to a plurality of slots provided on the front surface of the housing of the transmission apparatus, and are electrically connected to a wiring board provided on the rear surface of the housing, through electrical connectors. Thus, the plurality of line units 1 and the switch unit 2 exchange packets with each other.

The transmission apparatus may be further provided with a control unit that monitors and controls the plurality of line units 1 and the switch unit 2. In this case, the control unit exchanges control information with a network management device that manages a network, for example, through a local area network (LAN).

The transmission apparatus includes a monitoring control unit 10, an optical transceiver 11, a PHY/MAC unit 12, packet processing units 13a, 13b, traffic control units 14a, 14b, a switch interface (SW-IF) unit 15, look-up tables 16a, 16b, and packet buffers 17a, 17b. The look-up tables 16a, 16b and the packet buffers 17a, 17b include, for example, a storage unit such as a memory.

The optical transceiver 11 includes a receiver that receives an optical signal including a packet (PKT), through a transmission path 9a, and a transmitter that transmits an optical signal including a packet (PKT), through a transmission path 9b. The transmission paths 9a, 9b are, for example, optical fibers. The optical transceiver 11 generates an electrical signal by performing photoelectric transformation on the received optical signal and outputs it to the PHY/MAC unit 12. The optical transceiver 11 generates an optical signal by performing electro-optical transformation on the electrical signal which is input from the PHY/MAC unit 12, and outputs it to the optical transceiver 11.

The PHY/MAC unit 12 has functions of a physical (PHY) layer and a media access control (MAC) layer of communication. The PHY/MAC unit 12 takes out a packet from an electrical signal which is input from the optical transceiver 11, and outputs the packet to the packet processing unit 13a. Then, the PHY/MAC unit 12 outputs a packet which is input from the traffic control unit 14b as an electrical signal, to the optical transceiver 11.

The packet processing unit 13a and the traffic control unit 14a process a packet in an ingress direction, in other words, process a packet which is received from other apparatuses and output to the switch unit 2. In contrast, the packet processing unit 13b and the traffic control unit 14b process a packet in an egress direction, in other words, process a packet which is input from the switch unit 2 and output to other apparatuses.

The packet processing units 13a, 13b retrieve the destination of the packet, by respectively referring to the look-up tables 16a, 16b. The identifier, the port number and the like of the line unit 1 are registered in the look-up tables 16a, 16b, for example, so as to correspond to the source address (SA) and the destination address (DA) of the packet. The packet processing units 13a, 13b generate the look-up tables 16a, 16b, based on the learning result of the destination of the packet, by using for example, a MAC address learning function.

The packet processing units 13a, 13b assign information about the retrieved destination of a packet to the packet, while including the information in the device header. The packet processing units 13a, 13b respectively output the packet having the device header assigned thereto, to the traffic control units 14a, 14b.

The traffic control units 14a, 14b control the output rates of packets by temporarily storing the packets in the packet buffers 17a, 17b, respectively. This reduces a packet loss caused by packets being input to the line unit 1 and the switch unit 2 at a rate higher than a processing capacity.

The packet buffers 17a, 17b are examples of a storage unit. The packet buffers 17a, 17b have a plurality of regions respectively storing packets. The regions in the packet buffers 17a, 17b are specified by the address.

The traffic control unit 14a outputs the packet which is read from the packet buffer 17a to the SW-IF unit 15. The traffic control unit 14b outputs the packet which is read from the packet buffer 17b to the PHY/MAC unit 12.

The SW-IF unit 15 outputs a packet which is input from the traffic control unit 14a to the switch unit 2. The SW-IF unit 15 outputs the packet which is input from the switch unit 2 to the packet processing unit 13b. The switch unit 2 transmits the packet to the line unit 1 corresponding to the destination of the packet, by referring to the device header of the packet which is input from the line unit 1.

The monitoring control unit 10 includes, for example, a circuit including a central processing unit (CPU), and performs the monitoring control of the packet processing units 13a, 13b and the traffic control units 14a, 14b. The monitoring control unit 10 collects, for example, alarms of the packet processing units 13a, 13b and the traffic control unit 14a, 14b, at a certain time period, and transmits the alarms to the network management device.

When a failure occurs in the transmission apparatus, the monitoring control unit 10 collects the logs (in other words, snapshots) of the packets left in the packet buffers 17a, 17b from the traffic control units 14a, 14b, and sends the logs to the network management device. The warning and the log of a packet are useful for the network management device to specify the failure cause of the transmission apparatus.

However, in a case of a comparative example described below, there is a problem that it is not possible to acquire the logs of the packets before and after the time when a failure occurs, according to the time series.

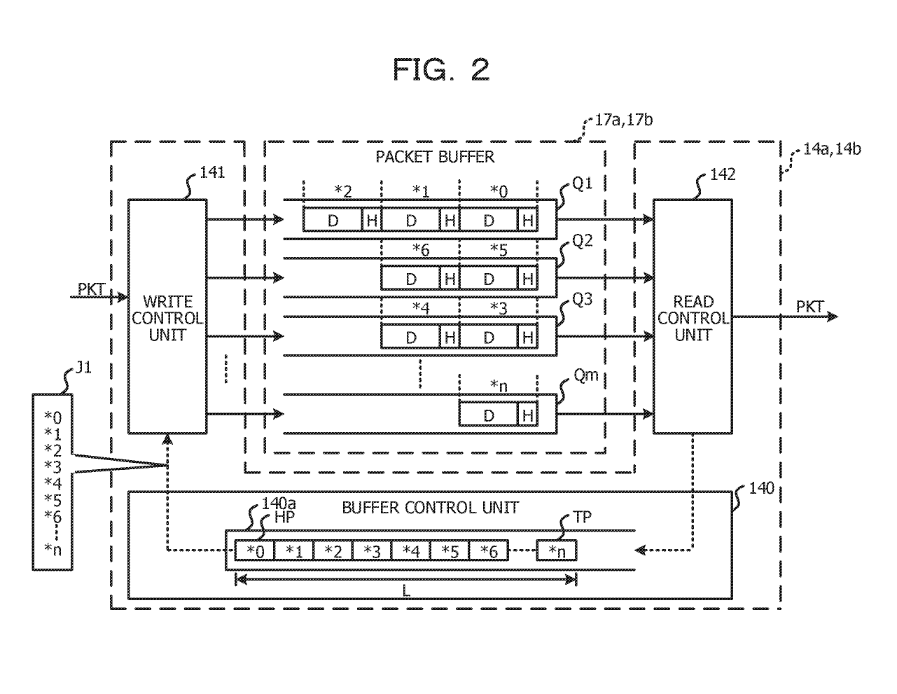

FIG. 2 is a configuration diagram illustrating a comparative example of the traffic control units 14a, 14b and the packet buffers 17a, 17b (at the time of writing a packet). The traffic control units 14a, 14b each include a buffer control unit 140, a write control unit 141, and a read control unit 142.

The write control unit 141 is an example of a writing unit, and sequentially writes a packet to a plurality of regions in the packet buffers 17a, 17b. The write control unit 141 divides the packet in units of predetermined amounts of packet data D, and writes each piece of packet data D in the packet buffers 17a, 17b, while assigning a device header H to each piece of packet data D. For example, in a case of dividing a packet in units of 64 (Bytes), the packet of a 128 (Bytes) length is divided into two pieces of packet data D.

The packet data D having a device header H assigned thereto is stored in queues Q1, Q2, Q3, . . . , Qm for respective packets, which are provided virtually in the packet buffers 17a, 17b. In the example of FIG. 2, a packet which is divided into three pieces of packet data D are stored in the queue Q1. Packets respectively divided into two pieces of packet data D are stored in the queues Q2 and Q3. FIG. 2 illustrates an example in which packets are respectively stored in m queues Q1 to Qm. However, the number of queues Q1 to Qm varies depending on the number of packets to be stored.

“*0”, “*1”, “*2”, . . . , “*n” (n: a positive integer) represent pointer information pieces indicating the regions in the packet buffers 17a, 17b in which packets are respectively stored. More specifically, pointer information pieces “*0”, “*1”, “*2”, . . . , “*n” represent the addresses of the regions in the packet buffers 17a, 17b.

In the example of FIG. 2, the packet in the queue Q1 is stored in the regions that “*0”, “*1”, and “*2” respectively indicate. The packet in the queue Q2 is stored in the regions that “*5” and “*6” respectively indicate. The packet in the queue Q3 is stored in the regions that “*3” and “*4” respectively indicate.

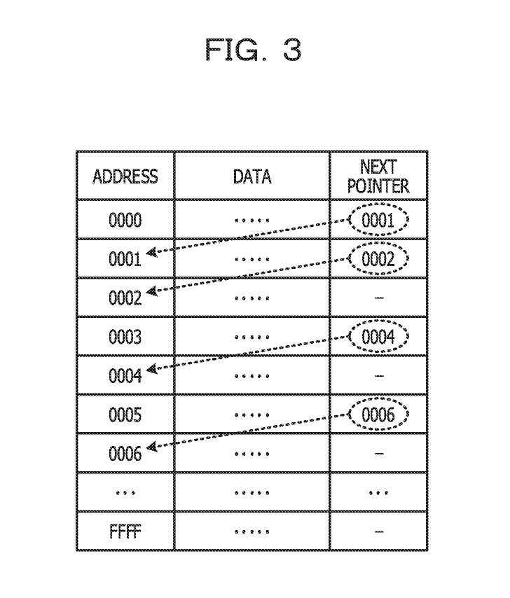

FIG. 3 is a diagram illustrating an example of a map of the packet buffers 17a, 17b. The packet buffers 17a, 17b store data including the device header H and the packet data D for each address. The address is expressed by the hexadecimal number. “0000” to “0006” are addresses of the regions that the pointer information pieces “*0” to “*6” respectively represent.

In a case where a packet is stored over a plurality of regions, the next pointer represents the address of the region in which the next data is to be stored, as indicated by arrows, in order to link data pieces of the respective regions. For example, the packet of the queue Q1 of FIG. 2 is stored over the regions of the addresses “0000” to “0002” which are indicated by pointer information pieces “*0” to “*2”. Therefore, the next pointer of the address “0000” indicates “0001”, and the next pointer of the address “0001” indicates “0002”.

Therefore, in a case where the packet stored in the queue Q1 is read, data pieces of addresses “0000” to “0002” are sequentially referred to. The next pointer of “−” indicates that there is no next data to be linked.

The packet of the queue Q2 is stored over the regions of the addresses “0005” and “0006” which are indicated by pointer information pieces “*5” and “*6”. Therefore, the next pointer of the address “0005” indicates “0006”. Further, the packet of the queue Q3 is stored over the regions of the addresses “0003” and “0004” which are indicated by pointer information pieces “*3” and “*4”. Therefore, the next pointer of the address “0003” indicates “0004”.

If FIG. 2 is referred to again, the read control unit 142 sequentially reads packets from the respective regions in the packet buffers 17a, 17b. The read control unit 142 outputs the pointer information pieces indicating the addresses of the packet buffers 17a, 17b from which reading of packets is completed, to the buffer control unit 140, in the read-out order.

The buffer control unit 140 includes a pointer queue 140a that stores pointer information which is input from the read control unit 142, in the input order. The buffer control unit 140 manages the length (data amount) of a head pointer HP which is the pointer information stored at the top of the pointer queue 140a, a tail pointer TP which is the pointer information stored at the tail of the pointer queue 140a, and all pieces of pointer information stored in the pointer queue 140a.

The buffer control unit 140 outputs the pointer information of the head pointer HP to the write control unit 141, in response to a request from the write control unit 141. In other words, the pointer information pieces which are stored in the pointer queue 140a are sequentially output to the write control unit 141, from the first piece. Therefore, the order of the pointer information pieces which are stored in the pointer queue 140a and the order of the pointer information pieces which are output from the pointer queue 140a are the same. The write control unit 141 sequentially writes packets in the regions indicated by the pointer information which are input from the buffer control unit 140.

In this example, pointer information pieces “*0”, “*1”, “*2”, . . . , “*n” are stored in the pointer queue 140a, in this order. Therefore, the buffer control unit 140 outputs the pointer information to the write control unit 141, in the storage order (“*0”, “*1”, “*2”, . . . , “*n”), as indicated by a reference symbol J1. Accordingly, the write control unit 141 sequentially stores packets in the regions indicated by pointer information pieces “*0”, “*1” “*2” . . . , “*n” in other words, the respective regions of the addresses “0000”, “0001”, “0002”, . . .

More specifically, a first packet is written to the regions (address “0000” to “0002”) indicated by the pointer information pieces “*0” to “*2”. A second packet is written to the regions (address “0003” and “0004”) indicated by the pointer information “*3” and “*4”. A third packet is written to the regions (address “0005” and “0006”) indicated by the pointer information “*5” and “*6”.

Thus, the write control unit 141 writes packets in the regions of the addresses from which packets are read and released by the read control unit 142, in the order of release. However, as described below, the order of the packets which are written into the packet buffers 17a, 17b and the order of the packets which are read from the packet buffers 17a, 17b are different, because the priority of reading is provided for each packet.

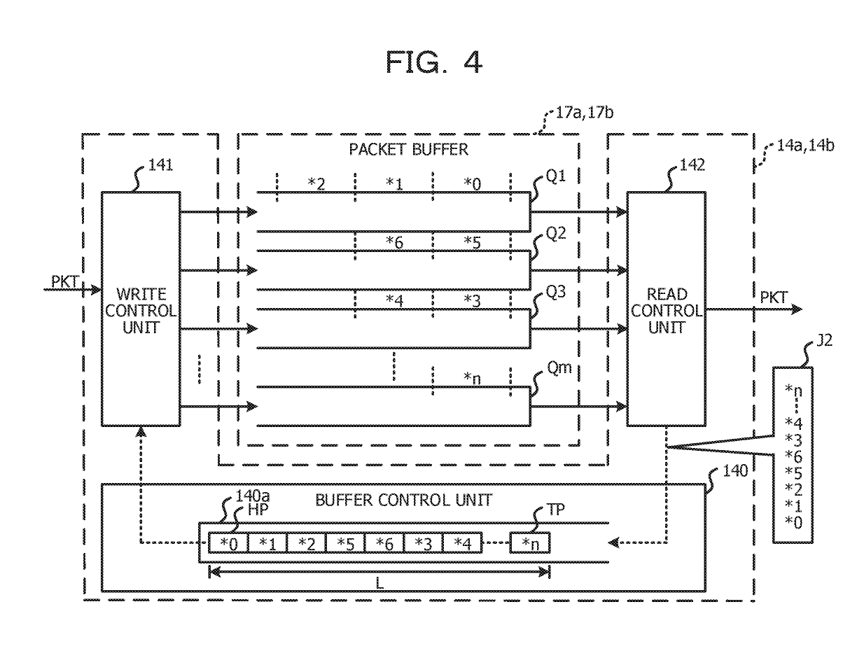

FIG. 4 is a configuration diagram illustrating the comparative example of the traffic control units 14a, 14b and the packet buffers 17a, 17b (at the time of packet reading). In FIG. 4, the components which are common to those in FIG. 2 are denoted by the same reference numerals, and thus a description thereof will be omitted.

The read control unit 142 determines a priority for each packet, in other words, the priority for each of the queues Q1 to Qm, and reads packets in a descending order of the priority. The priority is determined based on, for example, the priority of the destination of a packet and the virtual LAN (VLAN) tag in the packet. Therefore, the packets are read from the buffer in an order different from the order in which the packets are stored in the packet buffers 17a, 17b.

In this example, if assuming that the priority of the queue Q2 is lower than that of the queue Q1, and is higher than that of the queue Q3, the read control unit 142 reads a packet from the queue Q1, and thereafter reads a packet from the queue Q2 earlier than the queue Q3. In other words, the late arrival packet of the queue Q2 is read earlier than the early arrival packet of the queue Q3. Therefore, the read control unit 142 outputs the pointer information pieces “*0”, “*1”, “*2”, “*5”, “*6”, “*3”, “*4”, . . . , “*n” to the buffer control unit 140 in this order, as indicated by a reference symbol J2.

Accordingly, the pointer information pieces “*0”, “*1”, “*2”, “*5”, “*6”, “*3”, “*4”, . . . , “*n” are stored in the pointer queue 140a, in this order. In other words, the storage order of the pointer information of the pointer queue 140a is different from that of the example of FIG. 2. Therefore, each time the packet buffers 17a, 17b read packets, a difference between the order of writing a packet to the respective regions in the packet buffers 17a, 17b and the initial order is increased.

As described above, in a case where the late arrival packet is read earlier than the early arrival packet from the buffer, if a new packet is stored in the region in the packet buffers 17a, 17b in which the late arrival packet was stored, the snapshot of the late arrival packet is overwritten. Therefore, since it is not possible to acquire the logs of the packets before and after the time when a failure occurs according to the time series, log analysis is difficult.

Therefore, in the example, since a write time is recorded for each of packets which are sequentially written in a plurality of regions in the packet buffers 17a, 17b, and an order of regions to which new packets are written is determined, based on the time information of the packet which is sequentially read from each region, the log analysis is facilitated.

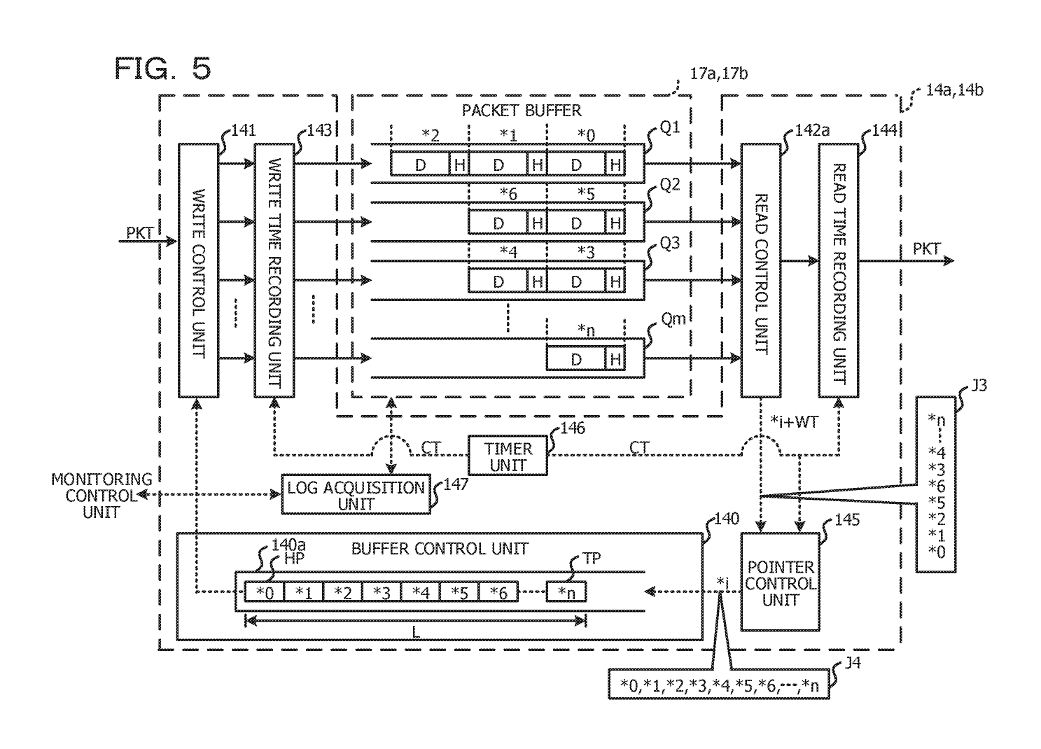

FIG. 5 is a configuration diagram illustrating an example of the traffic control units 14a, 14b, and the packet buffers 17a, 17b. In FIG. 5, the components which are common to those in FIG. 2 are denoted by the same reference numerals, and thus a description thereof will be omitted.

The traffic control units 14a, 14b each include a buffer control unit 140, a write control unit 141, a read control unit 142a, a write time recording unit 143, a read time recording unit 144, a pointer control unit 145, a timer unit 146, and a log acquisition unit 147.

The log acquisition unit 147 acquires the logs of the packets stored in the packet buffers 17a, 17b, as snapshots, in response to a request from the monitoring control unit 10. When a failure occurs in the transmission apparatus, the monitoring control unit 10 requests, for example, log acquisition. The log acquisition unit 147 outputs the acquired snapshot to the monitoring control unit 10.

The timer unit 146 counts the current time CT, based on, for example, a pulse signal which is input from the outside. The timer unit 146 notifies the write time recording unit 143, the read time recording unit 144, and the pointer control unit 145 of the current time CT.

The write time recording unit 143 is an example of the recording unit, and records time information (hereinafter, referred to as “write time”) indicating the time when the write control unit 141 writes a packet to the region in the packet buffers 17a, 17b, for each packet. More specifically, the write time recording unit 143 is provided between the write control unit 141 and the packet buffers 17a, 17b, and records the current time CT in the device header H of the packet which is input from the write control unit 141, as the write time WT. The packets having a write time recorded therein are input to the packet buffers 17a, 17b.

Therefore, the write time WT is recorded in the device header H of the packet which is stored in the packet buffers 17a, 17b, and the write time WT of a packet can be referred to, when the log of a packet is acquired from the packet buffers 17a, 17b. The write time recording unit 143 may record the write time WT in the table which is provided in the inside or the outside of the traffic control units 14a, 14b, as well as the device header H.

The read control unit 142a is an example of the reading unit. The read control unit 142a sequentially reads a packet from each of the plurality of regions in the packet buffers 17a, 17b. The read control unit 142a sequentially reads a packet in a descending order of a priority, similar to the read control unit 142 of the comparative example.

The read control unit 142a outputs the pointer information “*i” indicating the region in which the read packet was stored and the write time WT of the packet to the pointer control unit 145, each time the packet is read. More specifically, the read control unit 142a acquires the write time WT, from the device header H of the read packet. Then, the read control unit 142a arranges all pieces of pointer information indicating the regions in which the packets are stored, and outputs the pointer information to the pointer control unit 145.

The read time recording unit 144 is an example of an applying unit. The read time recording unit 144 applies read time information (hereinafter, referred to as “read time”) indicating the time when the read control unit 142a reads a packet from a plurality of regions in the packet buffers 17a, 17b, for each packet. More specifically, the read time recording unit 144 records the read time in the device header H of the packet which is input from the read control unit 142a. Therefore, if acquiring the log of the packet which is read from the traffic control units 14a, 14b, the read time of the packet can be referred to.

The pointer control unit 145 is an example of a determination unit, and an order in which the write control unit 141 writes a new packet to the respective regions in the packet buffers 17a, 17b from which packets are read is determined, based on the write time WT of each packet read by the read control unit 142a. Therefore, the write control unit 141 sequentially writes a new packet according to the order of the write time WT corresponding to a free region, to each free region in the packet buffers 17a, 17b. Accordingly, the write control unit 141 can write a packet to each region in the packet buffers 17a, 17b, in a certain order, different from the comparative example.

Thus, even in a case where the late arrival packet is read earlier than the early arrival packet from the buffer, a new packet is stored in the region in which the late arrival packet was stored, such that the overwriting of the snapshot of the late arrival packet is reduced. Therefore, the log acquisition unit 147 can acquire the logs of the packets before and after the time when a failure occurs, from the packet buffers 17a, 17b, according to the time series.

More specifically, the pointer control unit 145 rearranges the pointer information which is input from the read control unit 142a, in time series, based on the write time WT corresponding to each piece of pointer information, and outputs the pointer information to the buffer control unit 140. For example, the read control unit 142a outputs the pointer information pieces “*0”, “*1”, “*2”, “*5”, “*6”, “*3”, “*4”, . . . , “*n” to the pointer control unit 145 in this order, as indicated by a reference symbol J3. In this case, the pointer control unit 145 rearranges the pointer information in the order of “*0”, “*1”, “*2”, “*3”, “*4”, “*5”, “*6”, . . . , “*n”, according to the time series, and outputs the pointer information to the buffer control unit 140, as indicated by a reference symbol J4.

Therefore, the pointer information pieces “*0”, “*1”, “*2”, “*3”, “*4”, “*5”, “*6”, . . . , “*n” are stored in the pointer queue 140a, in this order. Accordingly, the write control unit 141 writes a new packet to the respective regions in the packet buffers 17a, 17b indicated by the pointer information pieces “*0”, “*1”, “*2”, “*3”, “*4”, “*5”, “*6”, . . . , “*n”, in this order. Thus, new packets are normally written to the respective regions in the packet buffers 17a, 17b, in a certain order.

In this way, the pointer control unit 145 determines a region from which the packet of the oldest write time WT is read, among the write times WT for respective packets which are read by the read control unit 142a, as a region to which a new packet is to be first written. Accordingly, the oldest snapshot among snapshots of packets which are left in the packet buffers 17a, 17b can be overwritten by the new packet, and first erased. Hereinafter, the configuration of the pointer control unit 145 will be described.

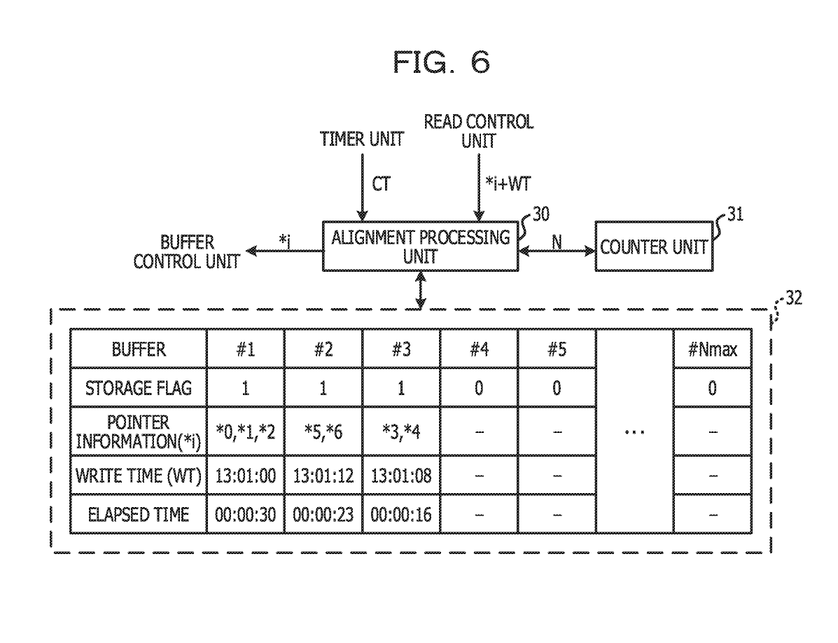

FIG. 6 is a configuration diagram illustrating an example of the pointer control unit 145. The pointer control unit 145 includes an alignment processing unit 30, a counter unit 31, and a pointer buffer unit 32.

The alignment processing unit 30 performs a process of rearranging the pointer information. The alignment processing unit 30 manages the pointer information (“*i”) and the write time WT which are input from the read control unit 142b, using the pointer buffer unit 32. The pointer buffer unit 32 stores a plurality of buffers #1 to #Nmax (Nmax: a positive integer) storing the pointer information, and a storage flag (“0”: not stored, and “1”: has been stored) indicating whether or not the pointer information for each of the buffers #1 to #Nmax is stored.

If the pointer information and the write time WT are input, the alignment processing unit 30 retrieves the buffer of storage flag=“0” in the ascending order of the identification numbers (#1 to #Nmax) of the respective buffers #1 to #Nmax. The alignment processing unit 30 stores the pointer information in the retrieved buffer. The pointer information is stored for each packet.

For example, since the first-read packet is stored in the regions (addresses “0000” to “0002”) indicated by the pointer information pieces “*0”, “*1”, and “*2”, the pointer information pieces “*0”, “*1”, “*2” are stored in the buffer #1. Since the second-read packet is stored in the regions (addresses “0005”, “0006”) indicated by the pointer information pieces “*5”, “*6”, the pointer information pieces “*5”, “*6” are stored in the buffer #2. Since the third-read packet is stored in the regions (addresses “0003”, “0004”) indicated by the pointer information pieces “*3”, “*4”, the pointer information pieces “*3”, “*4” are stored in the buffer #3. After the pointer information is stored, the storage flag is updated to “1”.

The write time WT and the elapsed time are stored in the pointer buffer unit 32 so as to correspond to the pointer information of each of the buffers #1 to #Nmax. The alignment processing unit 30 registers the write time WT corresponding to the buffer storing the pointer information. An elapsed time indicates a time that has elapsed after the pointer information is stored in the pointer buffer unit 32. The alignment processing unit 30 periodically updates the elapsed time, based on the current time CT that is input from the timer unit 146.

The counter unit 31 counts the number N of buffers in which the pointer information is stored, for each packet. The counter unit 31 adds 1 to the number N, each time the alignment processing unit 30 stores the pointer information in the buffer of the pointer buffer unit 32. When the number N of buffers reaches a certain maximum number Nmax of the buffer, the alignment processing unit 30 outputs the pointer information corresponding to the oldest write time WT, among the write times WT that are stored in the pointer buffer unit 32, to the write control unit 141, through the buffer control unit 140.

The maximum number Nmax of the buffer is set, based on the output rate of the packet in the queue having the lowest priority, out of queues Q1 to Qm of the packet buffers 17a, 17b, for example, as follows. It is assumed that four queues Q1 to Q4 are present in the packet buffers 17a, 17b, the priorities of the four queues Q1 to Q4 are respectively set to “4” (highest), “3”, “2”, “1” (lowest). Then, if the ratio of the output rates of packets of the respective queues Q1 to Q4 is set to Q1:Q2:Q3:Q4=4:3:2:1, in a case where the transmission processing speed of the line unit 1 is 100 (Gbps), the output rate of the queue Q4 having the lowest priority is 10 (Gbps) (=100× 1/10).

In a case where the length of the packet is variable, when a packet of a maximum length is stored in the queue Q4, the number of packets which are to be stored in other queues Q1 to Q3 later than the packet and are to be read earlier than the packet is the largest. Therefore, if the maximum length of a packet is 9600 (Bytes) (such as a jumbo frame), a time taken to read the packet of the maximum length which is stored in the queue Q4 is 7.68 (μsec) (=9600×8+10).

In a case where the packets stored in the queues Q1 to Q3 are all the shortest, the number of late arrival packets that are to be read earlier than the packets stored in the queue Q4 is the largest. Therefore, if the shortest length of a packet is 64 (Bytes), the number of packets which are to be read earlier from the queues Q1 to Q3, during the time 7.68 (μsec) taken to read the packet of the maximum length which is stored in the queue Q4, is 1037 (pieces) (=150 (pps)× 9/10×7.68).

Accordingly, in this example, the maximum number Nmax of the buffer in the pointer buffer unit 32 is set to 1037 (pieces). In the above calculation equation, 150 (pps) is a value obtained by replacing the transmission processing speed 100 (Gbps) with the rate of a packet of a 64 (Byte) length.

In this case, the number N that the counter unit 31 counts is 1037, and the alignment processing unit 30 outputs the pointer information having the oldest write time WT. Therefore, the alignment processing unit 30 can reliably rearrange the pointer information which is input from the read control unit 142a, in time series, based on the write time WT corresponding to each piece of pointer information, and output the pointer information to the buffer control unit 140.

The pointer information is stored in the pointer queue 140a in the buffer control unit 140, in an order in which the buffer control unit 140 outputs the pointer information. Therefore, the write control unit 141 writes a new packet to the region indicated by the pointer information that is output from the pointer control unit 145, according to the output order.

The alignment processing unit 30 monitors the elapsed time for each of the buffers #1 to #Nmax, and outputs the pointer information in the buffer for which the elapsed time exceeds a certain time, to the write control unit 141. Therefore, since the pointer information is stored in the pointer buffer unit 32 for a long time, the lack of regions for writing a new packet by the write control unit 141 is reduced.

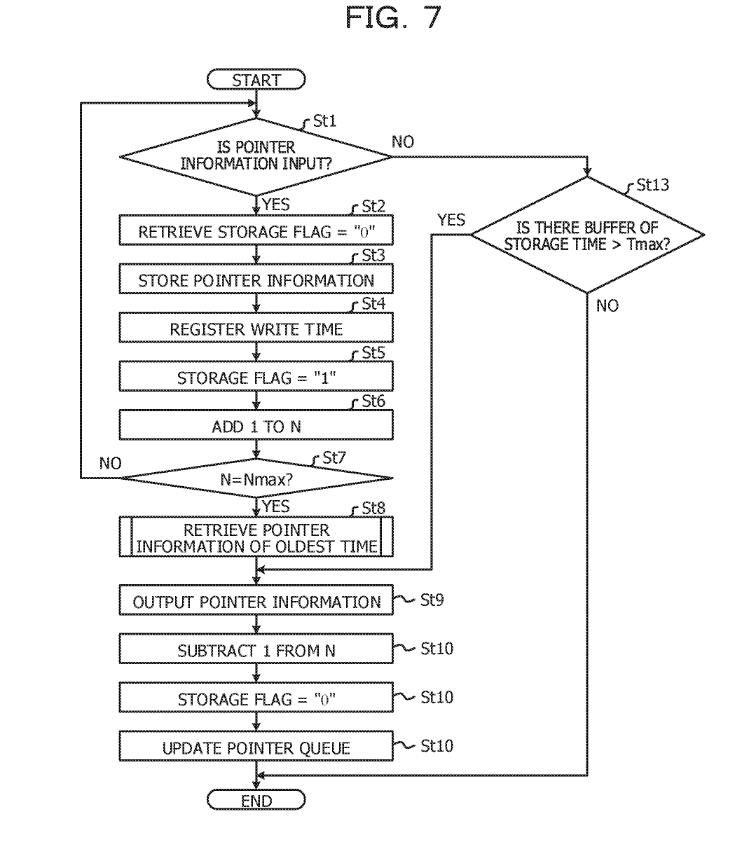

FIG. 7 is a flow chart illustrating an example of an output process for pointer information. This process is performed at a certain time period.

First, the alignment processing unit 30 determines whether or not the pointer information is input from the read control unit 142a (St1). Next, in a case where the pointer information is input (Yes in St1), the alignment processing unit 30 retrieves the buffer of storage flag=“0” in the ascending order of the identification number, from the buffers #1 to #Nmax of the pointer buffer unit 32 (St2).

Next, the alignment processing unit 30 stores pointer information in the retrieved buffers #1 to #Nmax (St3). Next, the alignment processing unit 30 registers the write time WT corresponding to the stored pointer information (St4). Next, the alignment processing unit 30 updates the storage flags corresponding to the buffers #1 to #Nmax storing the pointer information to “1” (St5).

Next, the counter unit 31 adds 1 to the number N of buffers #1 to #Nmax that have stored the pointer information (St6). Next, the alignment processing unit 30 determines whether or not the number N of buffers #1 to #Nmax reaches a certain maximum number Nmax (St7).

In the case of N≠Nmax (No in St7), the alignment processing unit 30 performs the process of St1 again. In the case of N=Nmax (Yes in St7), the alignment processing unit 30 retrieves the pointer information of the oldest write time WT, from the write times WT that are registered in the pointer buffer unit 32 (St8). The details of the retrieval process of St8 will be described later.

Next, the alignment processing unit 30 outputs the retrieved pointer information to the buffer control unit 140 (St9). The pointer information that is output from the alignment processing unit 30 is stored in the pointer queue 140a of the buffer control unit 140.

Next, the alignment processing unit 30 subtracts 1 from the number of buffers storing the pointer information (St10). Next, the alignment processing unit 30 updates the storage flags corresponding to the buffers #1 to #Nmax storing the pointer information to “0” (St11).

Next, the buffer control unit 140 updates the head pointer HP, the tail pointer TP, and the length L of the pointer queue 140a (St12), and ends the process.

In the case where the pointer information is not input (No in St1), the alignment processing unit 30 determines the presence or absence of buffers #1 to #Nmax for which the storage time exceeds the certain time Tmax (St13). The alignment processing unit 30 updates the storage time, separately from the present process.

In the case where there are no buffers #1 to #Nmax for which the storage time>Tmax (No in St13), the alignment processing unit 30 ends the process. In the case where there are buffers #1 to #Nmax for which the storage time>Tmax (Yes in St13), the alignment processing unit 30 outputs the pointer information stored in the buffer to the buffer control unit 140 (St9). Thus, the lack of regions in the packet buffers 17a, 17b for writing packets is reduced. Thereafter, the processes of St9 to St12 which are described above are performed. In this way, the output process of the pointer information is performed.

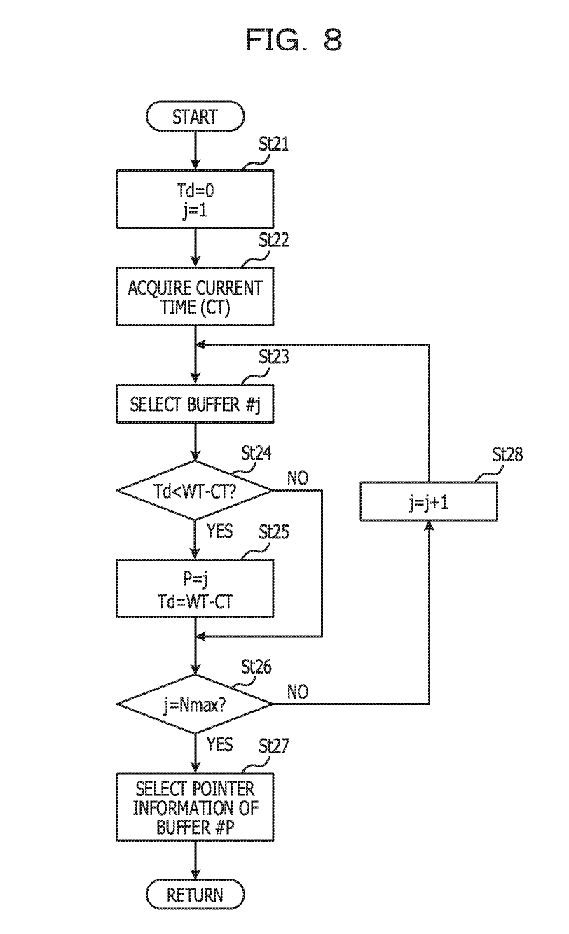

FIG. 8 is a flow chart illustrating an example of a retrieval process for pointer information (see St8 in FIG. 7). First, the alignment processing unit 30 sets 0 in the variable Td as an initial value, and sets 1 in the variable j as an initial value (St21). Next, the alignment processing unit 30 acquires the current time CT from the timer unit 146 (St22).

Next, the alignment processing unit 30 selects a buffer #j (St23). Next, the alignment processing unit 30 compares a difference (WT-CT) between the write time WT corresponding to the selected buffer #j and the current time CT, with the variable Td (St24).

Next, in a case where it is established that Td<WT−CT (Yes in St24), the alignment processing unit 30 sets the variable P=j, and Td=WT−CT (St25). In a case where it is established that Td WT−CT (No in St24), the alignment processing unit 30 does not perform the process of St25.

Next, the alignment processing unit 30 determines whether or not j=Nmax (St26). In a case of j≠Nmax (No in St26), the alignment processing unit 30 sets j=j+1 (St28). Thereafter, the alignment processing unit 30 performs the process of St23 again.

In a case of j=Nmax (Yes in St26), the alignment processing unit 30 selects the pointer information of the buffer #P as the output target (St27), and ends the process. The retrieval process of pointer information is performed in this way.

As described hitherto, the transmission apparatus according to the embodiment includes the packet buffers 17a, 17b, the write control unit 141, the write time recording unit 143, the read control unit 142a, and the pointer control unit 145. The packet buffers 17a, 17b have a plurality of regions for respectively storing packets.

The write control unit 141 sequentially writes packets to the plurality of regions, respectively. The write time recording unit 143 records the write times WT when the packets are written to the plurality of regions by the write control unit 141, for each packet. The read control unit 142a sequentially reads the packets from the plurality of regions, respectively.

The pointer control unit 145 determines the order in which the write control unit 141 writes a new packet, to each region from which the packet is read, among the plurality of regions, based on the write time WT for each read packet by the read control unit 142a.

According to the above configuration, the write control unit 141 sequentially writes new packets to the respective free regions in the packet buffers 17a, 17b, according to the order of the write time WT corresponding to free regions. Therefore, the write control unit 141 can write packets to the respective regions in the packet buffers 17a, 17b, in a certain order.

Thus, even in a case where a late arrival packet is read earlier than the early arrival packet from the buffer, a new packet is stored in the region where the late arrival packet was stored, such that the overwriting of the snapshot of the late arrival packet is reduced. Therefore, it becomes possible to acquire the logs of the packets before and after the time when a failure occurs, from the packet buffers 17a, 17b, according to the time series.

Thus, according to the transmission apparatus of the embodiment, the log can be easily analyzed.

The transmission method according to the embodiment includes the following steps.
Step (1): Sequentially writing a packet to each of a plurality of regions in the packet buffers 17a, 17b storing packets.
Step (2): Recording a write time WT when the packet is written to each of the plurality of regions, for each packet.
Step (3): Sequentially reading a packet from each of the plurality of regions.
Step (4): Determining an order to write a new packet to each region from which a packet is read, among the plurality of regions, based on the write time WT for each read packet.

Since the transmission method according to the embodiment has the same configuration as the above-mentioned transmission apparatus, the same effect as the content described above is achieved.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A packet control method implemented by a processor provided in a transmission apparatus including a buffer, the method comprising:
sequentially writing a plurality of packets which are received, to a plurality of regions in the buffer, when sequentially receiving the plurality of packets;
acquiring time information indicating a time when each of the plurality of packets is written to one of the plurality of regions, for each packet;
sequentially reading the plurality of packets from the plurality of regions;
determining an order to write a plurality of new packets to the plurality of regions, based on the time information of each of the plurality of packets which are read; and
writing the plurality of new packets to the plurality of regions, according to the determined order, when sequentially receiving the plurality of new packets.

2. The packet control method according to claim 1,
wherein the determining includes determining a region from which a packet corresponding to time information indicating an oldest time is read, among a plurality of pieces of the time information, as a region to which any one of the plurality of new packets is first written.

3. The packet control method according to claim 1, wherein
the reading includes acquiring pointer information indicating a region in which the read packet is stored, among the plurality of regions, and the time information of the read packet,
the determining includes storing the acquired pointer information in the buffer, and outputting pointer information corresponding to time information indicating an oldest time, among the plurality of pieces of time information, when the number of the stored pointer information pieces reaches a predetermined value, and
the sequentially writing a plurality of packets includes writing a new packet in a region indicated by the output pointer information.

4. The packet control method according to claim 1,
wherein the determining includes outputting pointer information for which an elapsed time after the pointer information is stored in the buffer exceeds a predetermined time, among a plurality of pieces of pointer information which are stored in the buffer.

5. The packet control method according to claim 1,
wherein the acquiring includes writing the time information in the packet which is written to each of the plurality of regions.

6. The packet control method according to claim 1,
wherein the reading includes writing read time information indicating a time when a packet is read, in the packet which is read from each of the plurality of regions.

7. The packet control method according to claim 1,
wherein the writing the plurality of received packets includes:
dividing each of the plurality of received packets into a plurality of pieces of packet data, and
assigning a device header to each of the plurality of pieces of packet data which are obtained by the dividing.

8. The packet control method according to claim 7,
wherein the writing the time information includes writing the time information to the device header of each of a plurality of pieces of packet data.

9. The packet control method according to claim 1,
wherein the acquiring includes writing the time information to a table provided in the transmission apparatus.

10. A transmission apparatus, comprising:
a memory; and
a processor coupled to the memory and configured to:
sequentially write a plurality of packets which are received, to a plurality of regions in the memory, when sequentially receiving the plurality of packets,
acquire time information indicating a time when each of the plurality of packets is written to one of the plurality of regions, for each packet,
sequentially read the plurality of packets from the plurality of regions,
determine an order to write a plurality of new packets to the plurality of regions, based on the time information of each of the plurality of packets which are read, and
write the plurality of new packets to the plurality of regions, according to the determined order, when sequentially receiving the plurality of new packets.

11. A non-transitory computer-readable storage medium storing a program that causes a processor provided in a transmission apparatus including a buffer to execute a process, the process comprising:
sequentially writing a plurality of packets which are received, to a plurality of regions in the memory, when sequentially receiving the plurality of packets;
acquiring time information indicating a time when each of the plurality of packets is written to one of the plurality of regions, for each packet;
sequentially reading the plurality of packets from the plurality of regions;
determining an order to write a plurality of new packets to the plurality of regions, based on the time information of each of the plurality of packets which are read; and
writing the plurality of new packets to the plurality of regions, according to the determined order, when sequentially receiving the plurality of new packets.
